(19) United States
(12) Patent Application Publication
(10) Pub. No.: US 2023/0143666 A1
(43) Pub. Date: May 11, 2023

(54) MODEL PRODUCTIZATION ASSESSMENT

(71) Applicant: INTERNATIONAL BUSINESS MACHINES CORPORATION, Armonk, NY (US)

(72) Inventors: Rahul NAIR, Dublin (IE); Andrew T. PENROSE, Dublin (IE)

(73) Assignee: INTERNATIONAL BUSINESS MACHINES CORPORATION, Armonk, NY (US)

(21) Appl. No.: 17/454,568

(22) Filed: Nov. 11, 2021

(51) Int. Cl. G06K 9/62; G06N 3/08

(52) U.S. Cl. CPC G06K 9/6262; G06N 3/08

(57) ABSTRACT

Various embodiments are provided for improving machine learning model integration using one or more processors in a computing system. One or more artifacts of one or more machine learning models may be inspected. A degree of compatibility may be determined between the one or more machine learning models and an application based on inspecting the one or more artifacts. One or more adjustments may be recommended to the one or more artifacts based on the degree of compatibility for integrating the one or more machine learning models into the application.

### BACKGROUND OF THE INVENTION

### Field of the Invention

The present invention relates in general to computing systems, and more particularly to, various embodiments for improving machine learning model integration for model productization assessment in a computing system using a computing processor.

### Description of the Related Art

Computing systems may be found in the workplace, at home, or at school. Due to the recent advancement of information technology and the growing popularity of the Internet, a wide variety of computer systems have been used in machine learning. Machine learning is a form of artificial intelligence that is employed to allow computers to evolve behaviors based on empirical data. Machine learning may take advantage of training examples to capture characteristics of interest of their unknown underlying probability distribution. Training data may be seen as examples that illustrate relations between observed variables. A major focus of machine learning research is to automatically learn to recognize complex patterns and make intelligent decisions based on data.

### SUMMARY OF THE INVENTION

According to an embodiment of the present invention, a method for improving machine learning model integration (e.g., machine learning model productization assessor/assessment) in a computing system, by one or more processors, is depicted. One or more artifacts of one or more machine learning models may be inspected. A degree of compatibility may be determined between the one or more machine learning models and an application based on inspecting the one or more artifacts. One or more adjustments may be recommended to the one or more artifacts based on the degree of compatibility for integrating the one or more machine learning models into the application.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5 is a block diagram depicting an exemplary system and functionality for improving machine learning model integration in a computing environment by a processor in which aspects of the present invention may be realized.

FIG. 6 is a diagram depicting exemplary pseudocode for improving machine learning model integration in a computing environment by a processor in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

Currently, data scientists, who work on a machine learning model by gathering data, design a modelling task, run experiments to build/select machine learning model pipelines, evaluate selected machine learning model pipelines for a specific task, and conclude with documentation of the machine learning model using factsheets/model cards. A product offering manager/team, who look to leverage the functionality exposed by an artificial intelligence (“AI”) model seek to include in their software offerings. In doing so, these user may try to determine the requirements for a machine learning model, determine whether the machine learning model requires any specialized hardware or runtimes, determine a rate in which the machine learning model can provide inference, determine performance metrics (accuracy, etc.), determine any and all dependencies relating to the machine learning model, determine whether the machine learning model is exposed to standard application programming interfaces (“APIs”), determine if a machine learning model is implemented in standard tooling, a determine any bounds on behavior that limit applicability, and even what licensing agreement for third-party components are necessary.

Along with these challenges, another challenge is the operations for assessment of machine learning model artifacts for the purposes of productization is a time-consuming process with technical risks. In some aspect, “productization” in software may refers to taking a specific implementation of a functionality and making it available generally to a wide market (e.g., a commercial market) such as, for example, a tool written for one client and made more general and “productized” to be sold for several clients, machine learning models designed for one use case in one location, being made broadly available to other use cases for other locations, and attempting to reduce time/labor in understanding machine learning model artefacts is also time and labor intensive.

Accordingly, various aspects of the present invention provide for a system to assess productization of model artefacts relative to a reference declaration specification in an automated fashion. In some implementations, the present invention provide for automatically assessing artifacts relating to AI/machine learning models. In some implementations, any and all dependencies and technologies may be mapped to declared reference requirements of a product technology stack. An alert may be issued for indicating any dependency conflicts/incompatibilities. A reporting generator may provide a maturity assessment report that includes, for example, technology stacks, machine learning frameworks, optimization engines, etc. A recommendation of changes to be made to make AI model compatible with the overall product technologies.

To further illustrate, consider the following example. In some implementations, assume an AI applications team (e.g., data scientists) is tasked to productize an analytic from a research team. Also, assume there may be third party data coming from download locations such as, for example, from application programming interfaces (“APIs”) and from a data store containing a variety of types of data (e.g., image data). Thus, software codes may be generated using a particular type of programming language. Also, there may be assets that the analytic will run/execute against in terms of bounded field areas. The output may be provided as a particular data type (e.g., geotiffs).

Accordingly, it becomes imperative the AI applications team (e.g., data scientists) learn to understand how much work is needed in order to understand how to harden, transform and productionize the application/software code, which, currently, is a manual process, with no tooling available to provide an indication of what all the aspects included in the indication. Thus, the present invention provides a novel solution that provides an initial indication of an effort of the transform and in providing an advisement for productization.

In some implementations, the present invention provides for an artifact inspection tools that can examine code or artifact repositories, perform static analysis, and perform runtime analysis and tests. Also, the present invention provides for a dependency resolution operation that derives overall machine learning model requirements from inspection tools, resolves/extracts external dependencies, and may discover and learn requirement incompatibilities.

Also, the present invention provides for a requirements mapping operation that maps artifact requirements to abstract declarations of software system. A learning component is provided to learn relationships between input artifacts and output reports on compatibility scores.

In other implementations, an assessor component may be used to learn and reason about minimal changes in artifacts to make the machine learning artifacts compatible. In other implementations, a reporting component may be used to generate reports/alerts on model productization suitability and provide/assess a productization suitability score.

In some additional implementations, the present invention may improve machine learning model integration (e.g., machine learning model productization assessor/assessment) in a computing system, by one or more processors, is depicted. One or more artifacts of one or more machine learning models may be inspected. A degree of compatibility may be determined between the one or more machine learning models and an application based on inspecting the one or more artifacts. One or more adjustments may be recommended to the one or more artifacts based on the degree of compatibility for integrating the one or more machine learning models into the application.

Also, it should be noted that one or more calculations may be performed using various mathematical operations or functions that may involve one or more mathematical operations (e.g., performing rates of change/calculus operations, solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning model benefit). Optimize may also refer to making the most effective or functional use of a situation, opportunity, or resource.

Additionally, “optimize” need not refer to a best solution or result but may refer to a solution or result that “is good enough” for a particular application, for example. In some implementations, an objective is to suggest a “best” combination of preprocessing operations (“preprocessors”) and/or machine learning models, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

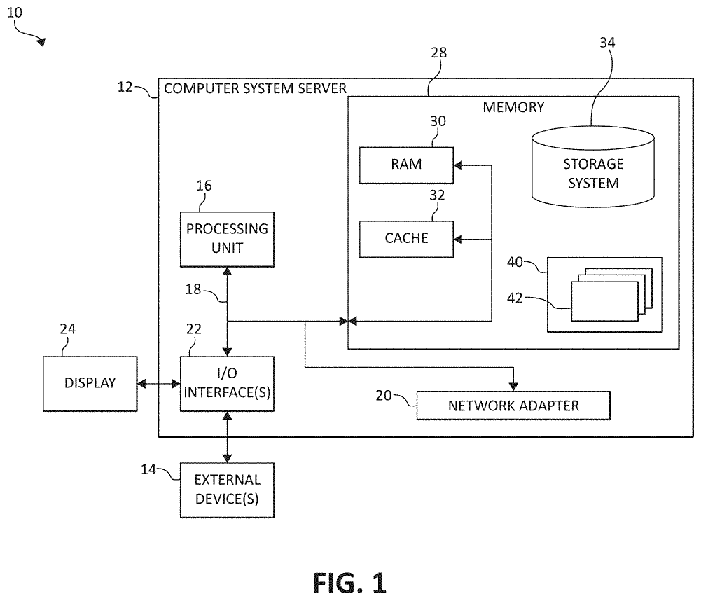

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

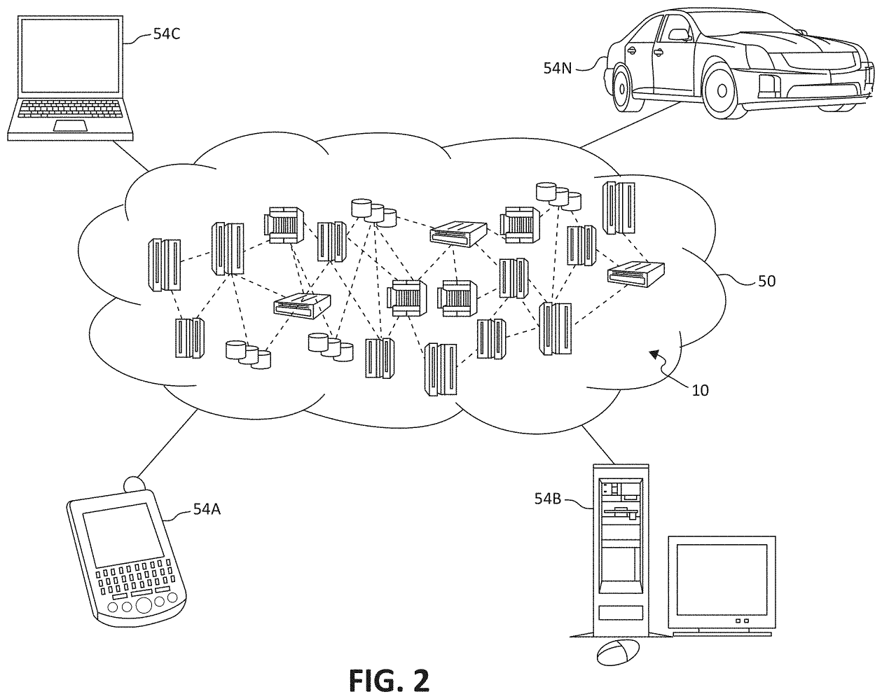

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

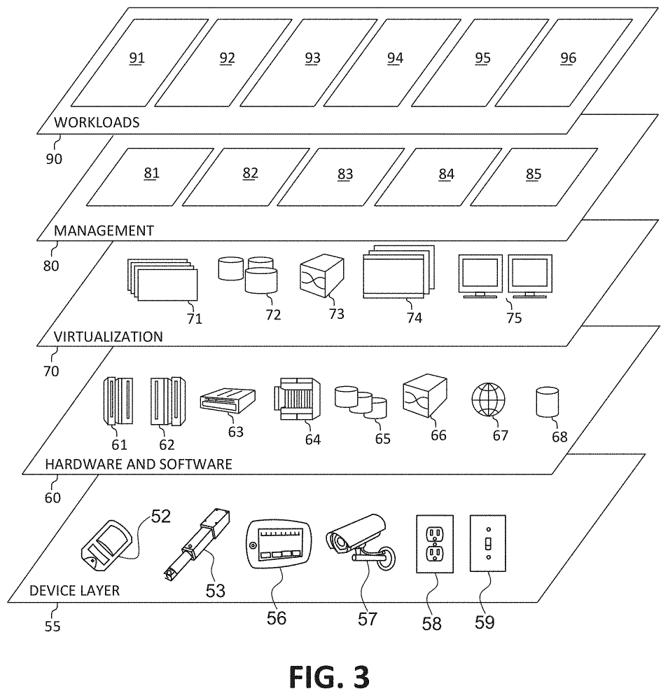

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for improving machine learning model integration in a computing system (e.g., in a neural network architecture). In addition, workloads and functions 96 for improving machine learning model integration in a computing system may include such operations as analytics, deep learning, and as will be further described, user and device management functions. One of ordinary skill in the art will appreciate that the workloads and functions 96 for improving machine learning model integration in a computing system in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for improving machine learning model integration in a computing environment in a computing system. One or more artifacts of one or more machine learning models may be inspected. A degree of compatibility may be determined between the one or more machine learning models and an application based on inspecting the one or more artifacts. One or more adjustments may be recommended to the one or more artifacts based on the degree of compatibility for integrating the one or more machine learning models into the application.

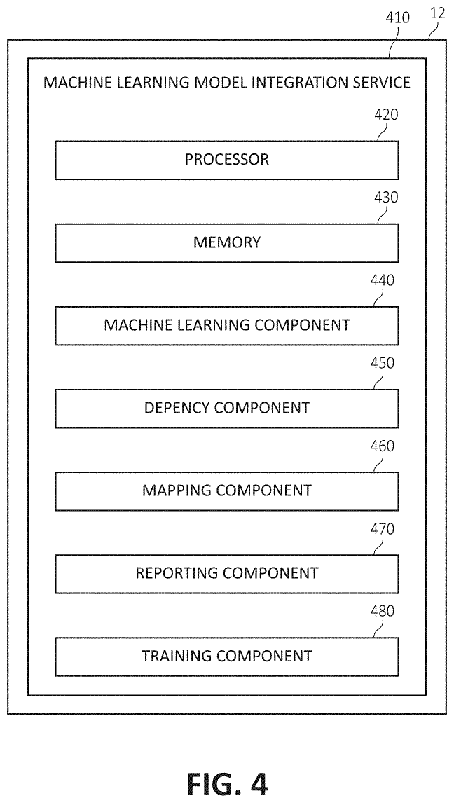

Turning now to FIG. 4, a block diagram depicting exemplary functional components of system 400 for improving machine learning model integration in a computing system in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

A machine learning model integration service 410 is shown, incorporating processing unit 420 (“processor”) to perform various computational, data processing and other functionality in accordance with various aspects of the present invention. In one aspect, the processor 420 and memory 430 may be internal and/or external to the machine learning model integration service 410, and internal and/or external to the computing system/server 12. The machine learning model integration service 410 may be included and/or external to the computer system/server 12, as described in FIG. 1. The processing unit 420 may be in communication with the memory 430. The machine learning model integration service 410 may include a machine learning component 440, a dependency component 450, a mapping component 460, a reporting component 470, and a training component 480.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The machine learning model integration service 410 may, using the machine learning component 440, the dependency component 450, the mapping component 460, the reporting component 470, and the training component 480 may inspect one or more artifacts of one or more machine learning models; determine a degree of compatibility between the one or more machine learning models and an application based on inspecting the one or more artifacts; and recommend one or more adjustments to the one or more artifacts based on the degree of compatibility for integrating the one or more machine learning models into the application.

The machine learning model integration service 410 may, using the machine learning component 440, and the dependency component 450, may learn one or more dependencies of the machine learning models in relation to one or more application.

The machine learning model integration service 410 may, using the machine learning component 440, and the dependency component 450, may learn a plurality of requirements, configuration elements, machine learning model parameters and versions, one or more pre-trained machine learning models, datasets, and external dependencies while inspecting the one or more artifacts.

The machine learning model integration service 410 may, using the machine learning component 440, and the dependency component 450, may establish machine learning training and timing requirements for one or more of the machine learning models by running a run-time analysis operation using testing data.

The machine learning model integration service 410 may, using the machine learning component 440, and the dependency component 450, may learn relationships between the one or more artifacts of the of one or more machine learning models and the degree of compatibility, wherein the degree of compatibility is a compatibility score.

The machine learning model integration service 410 may, using the machine learning component 440, and the mapping component 460, may map one or more dependencies of the one or more machine learning models to abstract reference declarations of the application.

The machine learning model integration service 410 may, using the machine learning component 440, the reporting component 470, and the training component 480, may generate one or more reports relating to machine learning model integration suitability into the application and provide a suitability score for integrating the one or more machine learning models into the application.

In one aspect, the machine learning component 440, as described herein, may be perform various machine learning operations using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also, even when deployed in a public environment (e.g., external to the controlled, testing environment), the computing devices may be monitored for compliance.

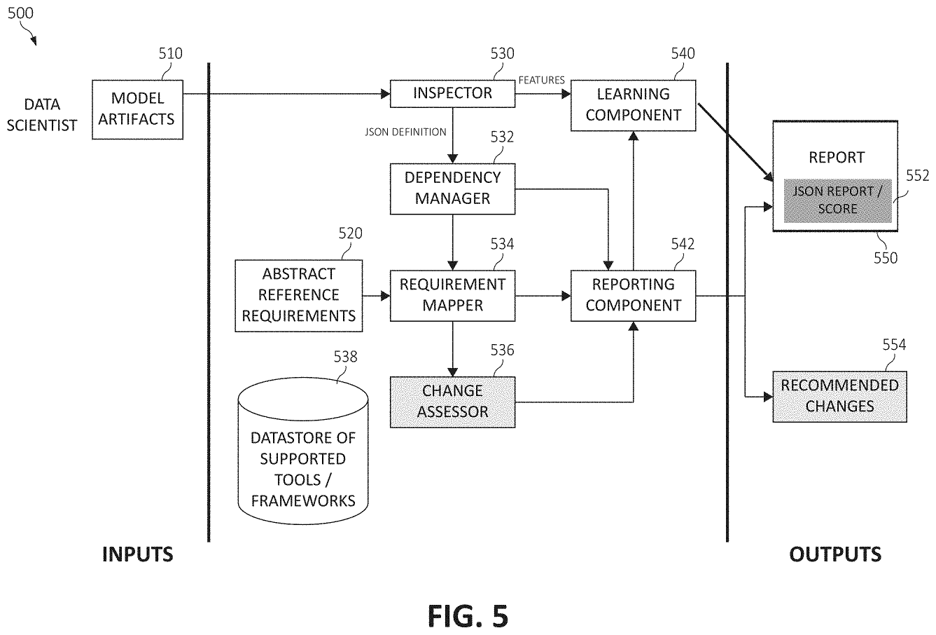

Turning now to FIG. 5, a block flow diagram depicts exemplary a system 500 and functionality for managing performance of a data processing system in a non-stationary environment in a computing environment in a computing environment. In one aspect, one or more of the components, modules, services, applications, and/or functions described in FIGS. 1-4 may be used in FIG. 5. As will be seen, many of the functional blocks may also be considered “modules” or “components” of functionality, in the same descriptive sense as has been previously described in FIGS. 1-4. Repetitive description of like elements employed in other embodiments described herein is omitted for sake of brevity.

As shown, the various blocks of functionality of system 500 are depicted with arrows designating the blocks' 500 relationships with each other and to show process flow. Additionally, descriptive information is also seen relating each of the functional blocks of system 500. As will be seen, many of the functional blocks of system 500 may also be considered “modules” or “components of functionality, in the same descriptive sense as has been previously described in FIGS. 1-4.

Starting in block 510, one or more model artifacts may be provided to an inspector component 530 (from a data scientist). The inspector component 530 may provide a static analysis by examining the model artifacts 510 to identify, learn, and establish any hardware requirements, specific configuration elements, machine learning frameworks and associated versions, use of pre-trained machine learning models, specific datasets, and other external dependencies. In some implementations, “features” may imply some structured information that is generated by the inspector component 530 (e.g., version numbers, requirements, etc., o other be semi-structured data) and may be used by the learning component to assess the output scores. “JSON definitions” refers to any information on the inspection results (e.g., specific pipelines, pre-trained components, requirements) that can be analyzed for dependencies. That is, the inspector component 530 may inspect the model artifact 510, which may include, examining application/software code or artifact repositories, perform static analysis, and perform runtime analysis and tests. The inspector component 530 may also execute a runtime analysis to configure runtime environments that allow for run time testing, using a suite of stress tests to establish training/inference time requirements.

A dependency manager 532 may leverage language-specific application dependency management tools to infer model dependencies for software components. The dependency manager 532 may provide transformation of inspection tool outputs into dependencies meta data for manager. The dependency manager 532 may use templates of standard tool/workflows (e.g., supported tools/frameworks in datastore 538) to match dependencies.

The dependency manager 532 may identify, extract, and/or derives overall machine learning model requirements from inspection tools, resolves/extracts external dependencies, and may discover and learn requirement incompatibilities (which may be executed in conjunction with the learning component 540).

The learning component 540, which may also be a compatibility assessor) may user one or more AI/machine learning models to learn a mapping of input artifacts to output compatibility scores.

The requirement mapper 534 may map one or more inferred dependencies to abstract reference declarations for a software solution. The requirement mapper 534 may map any and all dependencies and technologies to declared reference requirements of a product technology stack. Thus, the requirement mapper 534 may map artifact requirements to abstract declarations of software system. In some implementations, “abstract declarations” may refer to a software system that are relevant for productization such as, for example, a set of supported runtimes, etc. A change assessor component 536 may also learn and reason about one or more changes (e.g., a minimum number of changes) in the model artifacts 510 to make the artifacts compatible. In some implementations, the learning component 540 (e.g., a compatibility assessor) may learn what is different (relative to reference requirements) and the change assessor component 536 may learn what needs to change to make the in the model artifacts 510 compatible.

A reporting component 542 may provide (e.g., as output) a report 550 (e.g., an assessment report) that includes, for example, technology stacks, machine learning frameworks, optimization engines, etc. The report 550 may include a report with compatibility scores that can include inspection results such as, for example, a JavaScript Object Notation (“JSON”) report 552 with a score. The reporting component 542 may provide one or more recommended changes to enable the AI/machine learning model to increase in compatibility with an application/software solution. That is, the report 550 may recommend model or more changes to the model artifacts 510.

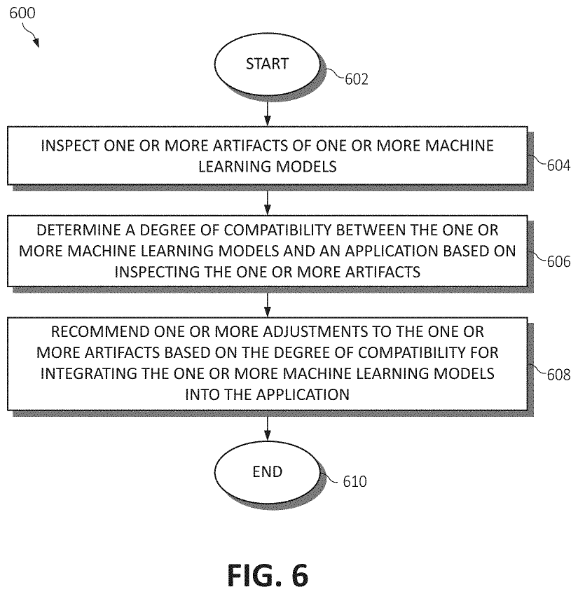

Turning now to FIG. 6, a method 600 for improving machine learning model integration in a computing environment using a processor is depicted. The functionality 600 may be implemented as a method executed as instructions on a machine, where the instructions are included on at least one computer readable medium or one non-transitory machine-readable storage medium. The functionality 600 may start in block 602.

One or more artifacts of one or more machine learning models may be inspected, as in block 604. A degree of compatibility may be determined between the one or more machine learning models and an application based on inspecting the one or more artifacts, as in block 606. One or more adjustments may be recommended to the one or more artifacts based on the degree of compatibility for integrating the one or more machine learning models into the application, as in block 608. The functionality 7600 may end, as in block 610.

In one aspect, in conjunction with and/or as part of at least one blocks of FIG. 6, the operations of 600 may include each of the following. The operations of 600 may learn one or more dependencies of the one or more machine learning models in relation to the one or more application. The operations of 600 may learn a plurality of requirements, configuration elements, machine learning model parameters and versions, one or more pre-trained machine learning models, datasets, and external dependencies while inspecting the one or more artifacts. The operations of 600 may establish machine learning training and timing requirements for the one or more machine learning models by running a run-time analysis operation using a plurality of testing data.

The operations of 600 may learn relationships between the one or more artifacts of the of one or more machine learning models and the degree of compatibility, wherein the degree of compatibility is a compatibility score. The operations of 600 may map one or more dependencies of the one or more machine learning models to abstract reference declarations of the application.

The operations of 600 may generate one or more reports relating to machine learning model integration suitability into the application; and provide a suitability score for integrating the one or more machine learning models into the application.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for improving machine learning model integration in a computing environment using one or more processors comprising:
inspecting one or more artifacts of one or more machine learning models;
determining a degree of compatibility between the one or more machine learning models and an application based on inspecting the one or more artifacts; and
recommending one or more adjustments to the one or more artifacts based on the degree of compatibility for integrating the one or more machine learning models into the application.

2. The method of claim 1, further including learning one or more dependencies of the one or more machine learning models in relation to the one or more application.

3. The method of claim 1, further including learning a plurality of requirements, configuration elements, machine learning model parameters and versions, one or more pre-trained machine learning models, datasets, and external dependencies while inspecting the one or more artifacts.

4. The method of claim 1, further including establishing machine learning training and timing requirements for the one or more machine learning models by running a run-time analysis operation using a plurality of testing data.

5. The method of claim 1, further including learning relationships between the one or more artifacts of the of one or more machine learning models and the degree of compatibility, wherein the degree of compatibility is a compatibility score.

6. The method of claim 1, further including mapping one or more dependencies of the one or more machine learning models to abstract reference declarations of the application.

7. The method of claim 1, further including:
generating one or more reports relating to machine learning model integration suitability into the application; and
providing a suitability score for integrating the one or more machine learning models into the application.

8. A system for improving machine learning model integration in a computing environment, comprising:
one or more computers with executable instructions that when executed cause the system to:
inspect one or more artifacts of one or more machine learning models;
determine a degree of compatibility between the one or more machine learning models and an application based on inspecting the one or more artifacts; and
recommend one or more adjustments to the one or more artifacts based on the degree of compatibility for integrating the one or more machine learning models into the application.

9. The system of claim 8, wherein the executable instructions when executed cause the system to learn one or more dependencies of the one or more machine learning models in relation to the one or more application.

10. The system of claim 8, wherein the executable instructions when executed cause the system to learn a plurality of requirements, configuration elements, machine learning model parameters and versions, one or more pre-trained machine learning models, datasets, and external dependencies while inspecting the one or more artifacts.

11. The system of claim 8, wherein the executable instructions when executed cause the system to establish machine learning training and timing requirements for the one or more machine learning models by running a run-time analysis operation using a plurality of testing data.

12. The system of claim 8, wherein the executable instructions when executed cause the system to learn relationships between the one or more artifacts of the of one or more machine learning models and the degree of compatibility, wherein the degree of compatibility is a compatibility score.

13. The system of claim 8, wherein the executable instructions when executed cause the system to map one or more dependencies of the one or more machine learning models to abstract reference declarations of the application.

14. The system of claim 8, wherein the executable instructions when executed cause the system to:
generate one or more reports relating to machine learning model integration suitability into the application; and
provide a suitability score for integrating the one or more machine learning models into the application.

15. A computer program product for increasing trustworthiness of an accelerator in heterogenous systems in a computing environment, the computer program product comprising:
one or more computer readable storage media, and program instructions collectively stored on the one or more computer readable storage media, the program instructions comprising:
program instructions to inspect one or more artifacts of one or more machine learning models;
program instructions to determine a degree of compatibility between the one or more machine learning models and an application based on inspecting the one or more artifacts; and
program instructions to recommend one or more adjustments to the one or more artifacts based on the degree of compatibility for integrating the one or more machine learning models into the application.

16. The computer program product of claim 15, further including program instructions to:
learn one or more dependencies of the one or more machine learning models in relation to the one or more application; and
learn a plurality of requirements, configuration elements, machine learning model parameters and versions, one or more pre-trained machine learning models, datasets, and external dependencies while inspecting the one or more artifacts.

17. The computer program product of claim 15, further including program instructions to establish machine learning training and timing requirements for the one or more machine learning models by running a run-time analysis operation using a plurality of testing data.

18. The computer program product of claim 15, further including program instructions to learn relationships between the one or more artifacts of the of one or more machine learning models and the degree of compatibility, wherein the degree of compatibility is a compatibility score.

19. The computer program product of claim 15, further including program instructions to map one or more dependencies of the one or more machine learning models to abstract reference declarations of the application.

20. The computer program product of claim 15, further including program instructions to:
generate one or more reports relating to machine learning model integration suitability into the application; and
provide a suitability score for integrating the one or more machine learning models into the application.
